(19) United States
(12) Patent Application Publication
(10) Pub. No.: US 2012/0073917 A1
(43) Pub. Date: Mar. 29, 2012

(54) DISC-ROTOR WITH A SEPARABLE ADAPTOR

(75) Inventor: Chel Won Lee, Wanju-gun (KR)

(73) Assignee: Hyundai Motor Company, Seoul (KR)

(21) Appl. No.: 13/237,210

(22) Filed: Sep. 20, 2011

(30) Foreign Application Priority Data
Sep. 28, 2010 (KR) 10-2010-0093905

(51) Int. Cl. F16D 65/12

(52) U.S. Cl. 188/218 XL

(57) ABSTRACT

A disc-rotor having an adaptor and a disc combined with the adaptor and braked by a caliper, may include the disc having a binding hole formed in the center thereof, a ring-shaped supporting member that may be formed at an interior circumference of the disc and in which a first bolt hole may be formed at the interior circumference thereof, the adaptor having both sides thereof open wherein a flange closely contacting the supporting member may be mounted at a side of the both sides and a second bolt holes may be formed at a circumference of the flange, and a fixing bolt that may be inserted in the first bolt hole and the second bolt hole such that the supporting member may be detachably engaged with the adaptor.

### CROSS-REFERENCE TO RELATED APPLICATION

The present application claims priority to Korean Patent Application No. 10-2010-0093905 filed in the Korean Intellectual Property Office on Sep. 28, 2010, the entire contents of which is incorporated herein for all purposes by this reference.

### BACKGROUND OF THE INVENTION

1. Field of the Invention

The present invention relates to a disc-rotor mounted for braking of a vehicle. More particularly, the present invention relates to a disc-rotor with a separable adaptor such that disc parts braked by a caliper can be separated from adaptor parts connected to a hub.

2. Description of Related Art

A disc-rotor mounted at a wheel hub of a bus or a truck is a part that rotates with wheel parts such as a tire, a wheel, or a hub during driving.

As shown in FIG. 1, a disc 30 and an adaptor 10 of a conventional disc-rotor 25 are integrally formed.

A caliper 50 is combined with the disc 30 so that a vehicle can be braked by a frictional force generated by closely contacting a brake lining 60 to the disc 30, and a hub (not shown) connecting a wheel with a driveshaft at a side of the disc 30 and the adaptor 10 are integrally formed so that these can be engaged by bolts.

For reference, ventilation fins 70 are formed between two discs so that frictional heat of a disc of a large vehicle can be easily cooled, and the adaptor 10 is integrally formed at a side of the disc 30.

However, heat distortion or cracks are easily created by the frictional heat during braking in the conventional disc-rotor 25 in which the adaptor 10 and a disc 30 are integrally formed.

Also, the frictional heat generated in the disc 30 is thermally conducted to the hub such that the braking performance can easily decline.

In particular, the frictional heat of a large vehicle is generated much more in proportion to the mass of the vehicle.

However, when the adaptor 10 and the disc 30 are integrally formed, there is no part that prevents thermal conduction between the disc 30 and the adaptor 10, so the heat of the disc 30 is transferred to the adaptor 10 such that it may be distorted, and a crack generated at the surface of the disc 30 reduces the life span of the brake lining 60.

Therefore, there are problems that the distortion and the crack reduce the lifespan of the hub and the caliper as well as the lifespan of the disc-rotor 25.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a disc-rotor with a separable adaptor such that heat distortion can be prevented and the heat distortion can occur in a radial direction even if the heat distortion occurs.

In an aspect of the present invention, the disc-rotor having an adaptor and a disc combined with the adaptor and braked by a caliper, may include the disc having a binding hole formed in the center thereof, a ring-shaped supporting member that may be formed at an interior circumference of the disc and in which a first bolt hole may be formed at the interior circumference thereof, the adaptor having both sides thereof open wherein a flange closely contacting the supporting member may be mounted at a side of the both sides and a second bolt holes may be formed at a circumference of the flange, and a fixing bolt that may be inserted in the first bolt hole and the second bolt hole such that the supporting member may be detachably engaged with the adaptor.

In another aspect of the present invention, a surface of the supporting member may be convexo-concave by gear teeth protruded from the surface of the supporting member, and a surface of the flange may be convexo-concave such that the flange and the supporting member may be engaged when the supporting member may be coupled with the adaptor.

The gear teeth may be formed at the circumference of the supporting member, and both sides of each gear tooth may be slanted.

In further another aspect of the present invention, a surface of the supporting member may be convexo-concave by first gear teeth protruded from the surface of the supporting member, and a surface of the flange may be convexo-concave by second gear teeth such that the first gear teeth of the supporting member and the second gear teeth of the flange may be engaged when the supporting member may be coupled with the adaptor.

The first gear teeth may be formed at the surface of the supporting member, and both sides of each first gear tooth may be slanted along a circumferential direction of the supporting member.

The second gear teeth may be formed at the surface of the flange, and both sides of each second gear tooth may be slanted along a circumferential direction of the flange.

The supporting member plays a role blocking thermal-conductivity, so the heat distortion is prevented.

Further, the gear teeth are so engaged together that the torque loss is prevented and the weight exerted on the fixing bolts is divided.

Also, slanted surfaces are so formed at both sides of the gear teeth that the disc and the adaptor can be assembled easily, and the scratches during close contacting can be prevented.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows a perspective view of the conventional disc-rotor, a perspective view of the disc-rotor engaged by a caliper, and a cross-sectional view of the disc-rotor.

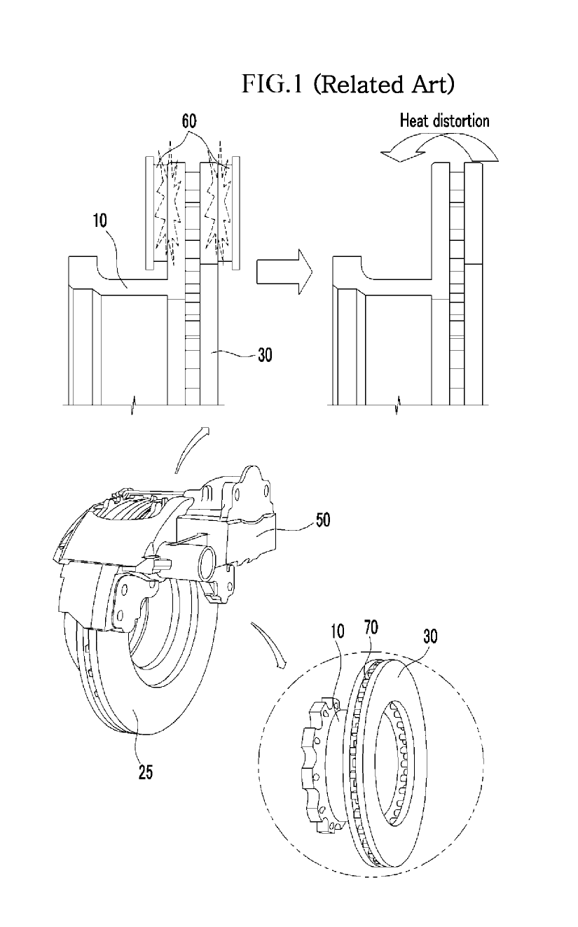

FIG. 2 shows a perspective view of the disc-rotor according to the exemplary embodiment of the present invention and an exploded perspective view thereof.

FIG. 3 shows a perspective view of a disc combined with a supporting member according to the exemplary embodiment of the present invention.

FIG. 4 shows a perspective view of an adaptor according to the exemplary embodiment of the present invention.

FIG. 5 shows a side surface and a cross-sectional view of an adaptor combined with the supporting member according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In a disc-rotor according to the exemplary embodiment of the present invention, the adaptor (hub mounted part) and the disc, which were integrally formed in the past, are separated such that the heat distortion by frictional heat is prevented, so thermal cracking can be fundamentally stopped.

Hereinafter, with reference to the accompanying drawings, a disc-rotor with a separable adaptor according to an exemplary embodiment of the present invention will be described in order for those skilled in the art to be able to implement the invention.

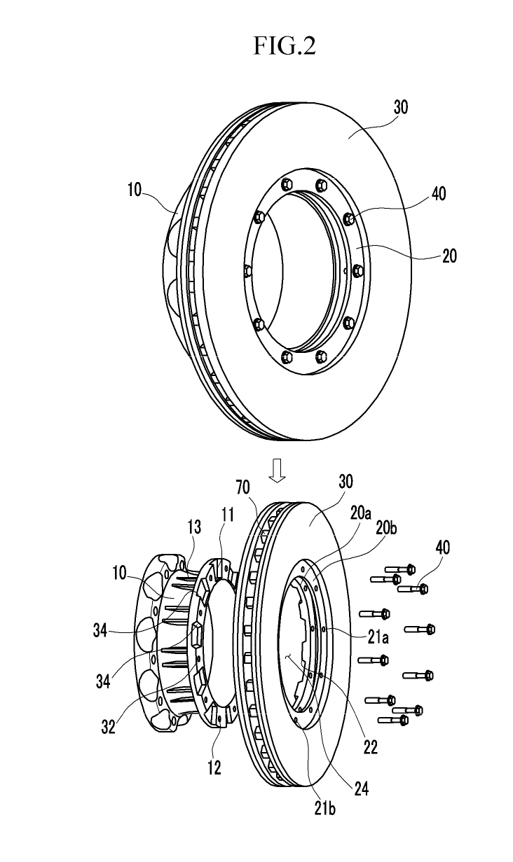

Referring to FIG. 2, in the disc-rotor according to the exemplary embodiment of the present invention, a disc 30, in which a binding hole 24 is formed in the center thereof, is combined with a ring-shaped supporting member 20 (20a and 20b).

Ventilation fins 70 are formed between two discs 30 in order to discharge heat efficiently as in a conventional disc-rotor.

The supporting members 20a and 20b are fixedly mounted at the interior circumference of the disc 30, and multiple first bolt holes 21a and 21b are formed at the circumference of the supporting members 20a and 20b.

The supporting members 20a and 20b are formed in parallel, and gear teeth 22 protrude at a portion combined with the adaptor 10.

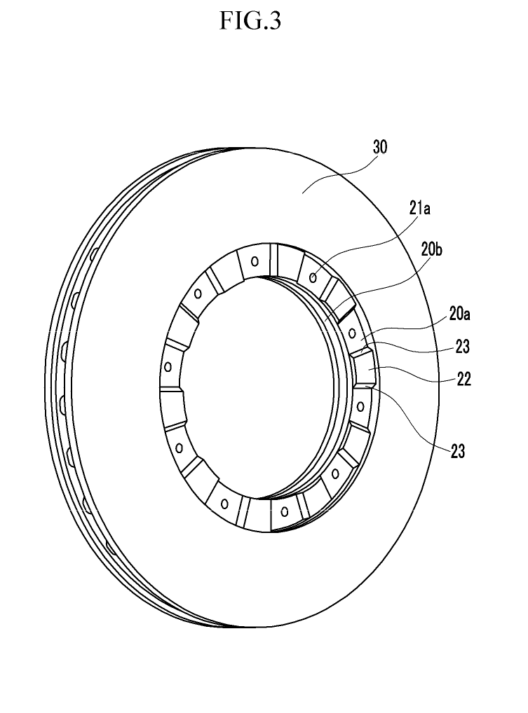

That is, as shown in FIG. 3, the combining surface of the supporting member 20a closely contacting the adaptor 10, which is located at the front, is convexo-concave.

Further, the gear teeth 22 are continually formed at the circumference of the supporting member 20a at predetermined intervals, and both sides of the gear teeth 22 may be slanted such that slanted surfaces 23 are formed.

Meanwhile, the adaptor 10 combined with the hub of a vehicle is formed as a pipe opened in both directions, and a flange 11 is formed at an end portion of the adaptor 10 in order to combine the supporting member 20a with the flange 11.

The flange 11 has convexo-concave surfaces engaged with the gear teeth 22 of the supporting member 20a.

In an exemplary embodiment of the present invention, the flange 11 may have gear teeth 32 that may be engaged with the corresponding gear teeth 22 of the supporting member 20a. Further, the gear teeth 32 are continually formed at the circumference of the flange 11 at predetermined intervals, and both sides of the gear teeth 32 may be slanted such that slanted surfaces 34 are formed.

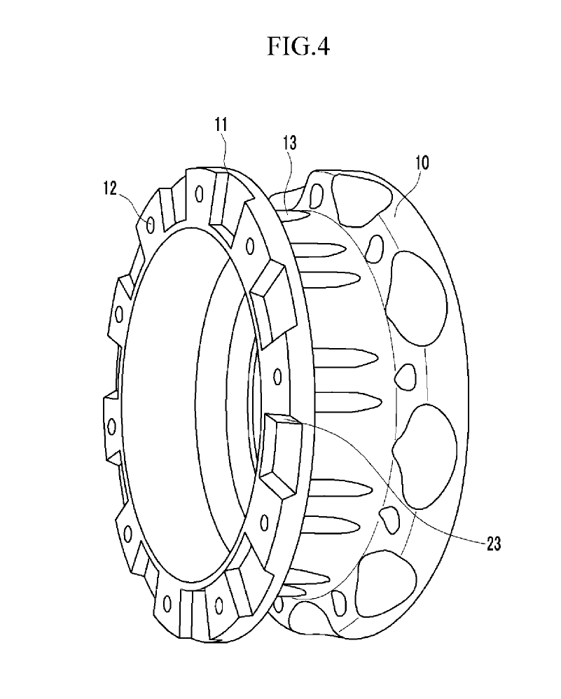

As shown in FIG. 4, second bolt holes 12 are formed at the circumference thereof. The second bolt holes 12 are formed in a line with the first bolt holes 21a and 21b such that fixing bolts 40 are inserted in the second bolt holes 12 and the first bolt holes 21a and 21b.

Further, ribs 13 can be formed on the exterior circumference of the adaptor 10 in order to reinforce the stiffness.

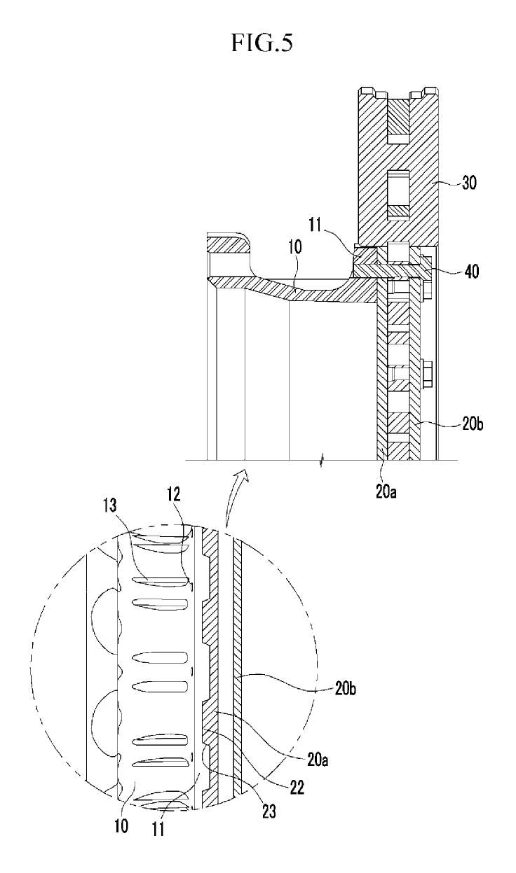

The above disc 30 and adaptor 10 are combined as shown in FIG. 5.

Referring to the drawing, the supporting members 20 (20a and 20b) are mounted at the interior circumference of the disc 30, and the flange 11 of the adaptor 10 is closely combined with the supporting member 20a.

The fixing bolts 40 are inserted in the first bolt holes 21a and 21b and the second bolt holes 12 so that the disc 30 and the adaptor 10 are engaged.

Meanwhile, the supporting member 20a and the adaptor 10 are engaged by the gear teeth 22, so these can transfer rotational force. Therefore, the diameter of the fixing bolt 40 can be designed to be smaller according to the size and the shape of gear teeth 22.

For convenience in explanation and accurate definition in the appended claims, the term “interior” is used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A disc-rotor having an adaptor and a disc combined with the adaptor and braked by a caliper, comprising:
the disc having a binding hole formed in the center thereof;
a ring-shaped supporting member that is formed at an interior circumference of the disc and in which a first bolt hole is formed at the interior circumference thereof;
the adaptor having both sides thereof open wherein a flange closely contacting the supporting member is mounted at a side of the both sides and a second bolt holes is formed at a circumference of the flange; and
a fixing bolt that is inserted in the first bolt hole and the second bolt hole such that the supporting member is detachably engaged with the adaptor.

2. The disc-rotor of claim 1, wherein a surface of the supporting member is convexo-concave by gear teeth protruded from the surface of the supporting member, and a surface of the flange is convexo-concave such that the flange and the supporting member are engaged when the supporting member is coupled with the adaptor.

3. The disc-rotor of claim 2, wherein the gear teeth are formed at the circumference of the supporting member, and both sides of each gear tooth are slanted.

4. The disc-rotor of claim 1, wherein a surface of the supporting member is convexo-concave by first gear teeth protruded from the surface of the supporting member, and a surface of the flange is convexo-concave by second gear teeth such that the first gear teeth of the supporting member and the second gear teeth of the flange are engaged when the supporting member is coupled with the adaptor.

5. The disc-rotor of claim 4, wherein the first gear teeth are formed at the surface of the supporting member, and both sides of each first gear tooth are slanted along a circumferential direction of the supporting member.

6. The disc-rotor of claim 4, wherein the second gear teeth are formed at the surface of the flange, and both sides of each second gear tooth are slanted along a circumferential direction of the flange.
